(19) United States
(12) Patent Application Publication
(10) Pub. No.: US 2005/0216439 A1
(43) Pub. Date: Sep. 29, 2005

(54) Update notification method and update notification apparatus of web page

(75) Inventor: Yasuhiro Kawakita, Tokyo (JP)

Correspondence Address: VENABLE LLP, P.O. BOX 34385, WASHINGTON, DC, 20045-9998, US

(73) Assignee: Oki Electric Industry Co., Ltd., Tokyo (JP)

(21) Appl. No.: 11/070,251

(22) Filed: Mar. 3, 2005

(30) Foreign Application Priority Data
Mar. 26, 2004 (JP) 2004-092858

(51) Int. Cl. G06F 7/00

(52) U.S. Cl. 707/1

(57) ABSTRACT

This invention provides an update notification method and an update notification apparatus capable of managing the contents of update of various Web pages in an integrated fashion and to browse the pages. In the Web page update notification method according to the invention, update of web page is externally notified by: accessing repeatedly at least one web site or web page identified by a preset address; extracting an update content from the web page when the web site or web page is updated; generating a formatted update content providing format information for specifying a string attribute of the update content to the update content; and notifying the formatted update content externally. The update notification apparatus according to the invention performs the method mentioned above.

### CROSS REFERENCE TO RELATED APPLICATIONS

The disclosure of Japanese Patent Application No. JP2004-092858, filed Mar. 26, 2004, entitled “UPDATE NOTIFICATION METHOD AND UPDATE NOTIFICATION APPARATUS OF WEB PAGE”. The contents of that application are incorporated herein by reference in their entirety.

### BACKGROUND OF THE INVENTION

The present invention relates to an update notification method and an update notification apparatus for notifying the update of Web page put on a network.

### DESCRIPTION OF THE RELATED ART

In recent years, many Web pages have been made public as a spread of the Internet, and various kinds of information are released by the Web site on company or individual basis. Since the Web pages are updated according to the convenience of each operator releasing the information, the update is normally implemented on irregular basis. For this reason, a user cannot learn of the update without successive access to the Web page. In addition, despite the access to confirm whether the update has been implemented or not, the information included in the Web page still remains old in many cases, which forces needless access in some cases.

In view of the aforementioned problem, according to Japanese Patent No. 3139408, for example, there is proposed a method or an apparatus for performing the service of notifying a user of the update of specific Web page. Also, according to Japanese Patent No. 3062104 and Japanese Patent Laid-Open Publication No.2002-73455, for example, there is proposed monitoring constantly the update of the file of Web server and notifying of the update and the outline thereof when the update has been implemented.

### SUMMARY OF THE INVENTION

In the conventional method or apparatus as described above, however, there is no common format for describing the information on the content of update of Web page. For this reason, it is difficult to manage a plurality of Web pages including various contents in an integrated fashion and to browse the pages, with the conventional method or apparatus as described above. In addition, with regard to the information on the Web site without the content of update provided, a user has no other choice but to access the Web site actually or to obtain the information by e-mail under the conventional update detection system.

An object of the invention is to provide an update notification method and an update notification apparatus capable of managing the contents of update of various Web pages in an integrated fashion and to browse the pages.

In order to solve the aforementioned problem, according to one aspect of the invention, there is provided an update notification method for notifying update of web page externally comprising: a step of accessing repeatedly at least one web site or web page identified by a preset address; an update content extracting step for extracting an update content from the web page when the web site or web page is updated; an update content generating step for generating a formatted update content providing format information for specifying a string attribute of the update content to the update content; and an update content notifying step for notifying the formatted update content externally.

In order to solve the above problem, according to another aspect of the invention, there is provided an update notification apparatus for notifying update of web page externally comprising: an update detecting part for accessing repeatedly at least one web site or web page identified by a preset address, and extracting an update content from the web page when the web site or web page is updated; an update content generating part for generating a formatted update content providing format information for specifying a string attribute of the update content to the update content; and an update content notifying part for notifying the formatted update content externally.

According to the invention, as described above, information on the update contents of various kinds of Web pages is notified together with the format information for specifying the string attribute thereof collectively. Thereby regardless whether the update information by RSS is provided from the Web site or not, the update contents of various kinds of Web pages can be managed and browsed in an integrated fashion.

### BRIEF DESCRIPTION OF THE DRAWINGS

The above and other features of the invention and the concomitant advantages will be better understood and appreciated by persons skilled in the field to which the invention pertains in view of the following description given in conjunction with the accompanying drawings which illustrate preferred embodiments.

FIG. 1 is a block diagram showing the whole configuration including an update notification apparatus according to the first embodiment.

FIG. 2 is a block diagram showing a detailed configuration of the update notification apparatus shown in FIG. 1.

FIG. 3 is an explanatory diagram showing a setting example in the case of requesting the update notification apparatus for update notification.

FIG. 4 is a flowchart showing the processing flow of the update notification apparatus.

FIG. 5 is an explanatory diagram for showing a method of obtaining a difference as an update content.

FIG. 6A is an explanatory diagram for showing one example of RSS data generated based on the update content.

FIG. 6B is an explanatory diagram for showing another example of RSS data generated from the update content.

FIG. 7 is an explanatory diagram for showing one example of content of a notice text including the update notification and the update content.

FIG. 8 is a diagram showing an example of screen in the case of browsing the update notification and the update content by a RSS reader.

FIG. 9 is a block diagram showing the whole configuration including an update notification apparatus according to the second embodiment.

### DETAILED DESCRIPTION OF THE PREFERRED EMBODIMENTS

Hereinafter, the preferred embodiment of the present invention will be described in reference to the accompanying drawings. Same reference numerals are attached to components having same functions in following description and the accompanying drawings, and a description thereof is omitted.

### First Embodiment

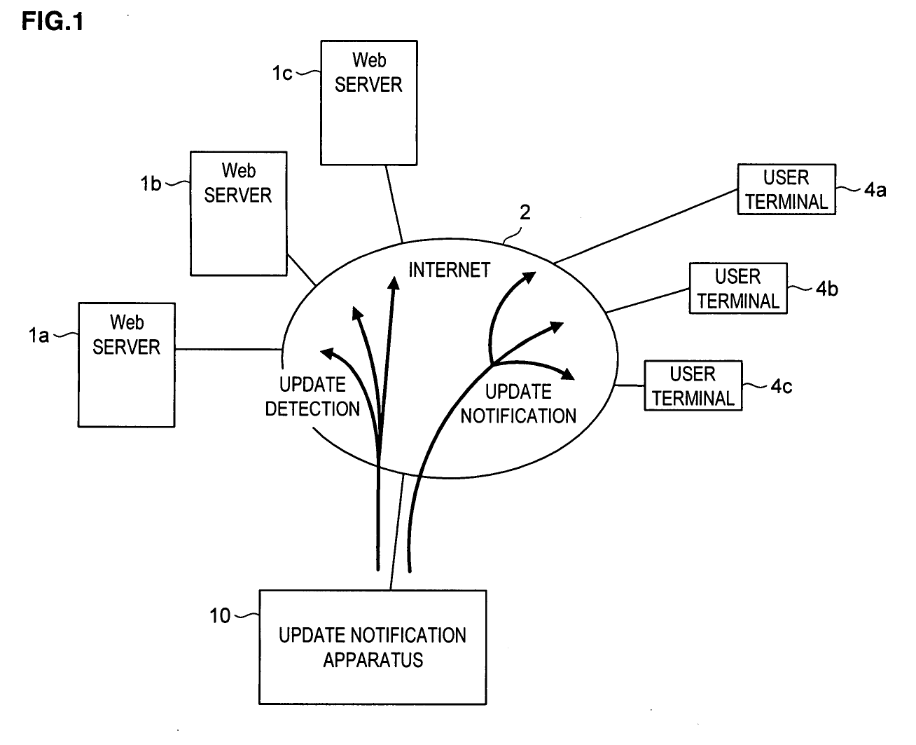

FIG. 1 shows the first embodiment of the invention and the whole configuration including an update notification apparatus 10. The update notification apparatus 10 is connected to a plurality of Web servers 1a-1c and a plurality of user terminals 4a-4c through the Internet 2. Each of the Web servers 1a-1c makes up a Web site on the Internet 2. Each of the Web servers 1a-1c, which has at least one Web page under a site address of the Web site, is a server computer for releasing the Web page to many computer terminals (not shown) including the user terminals 4a-4c connected to the Internet 2. The Web page, which is generally called homepage as well, is an information document released on the Internet and described mainly in HTML (Hyper Text Markup Language). The Web page is normally changed or updated on regular or irregular basis by an operator operating each of the Web servers 1a-1c or by a creator of Web page. The user terminals 4a-4c are terminals such as a computer used by a user informed of update from the update notification apparatus 10. In the description of this embodiment, although three Web servers 1a-1c and three user terminals 4a-4c are shown, the numbers thereof are not limited to this example. It suffices if the update notification apparatus 10 according to the invention is connected to at least one Web server and at least one user terminal. As a matter of course, the update notification apparatus 10 according to the invention may be connected to more Web servers and more user terminals.

The update notification from the update notification apparatus 10 to the user terminals 4a-4c is normally realized by sending a notice text in the form of e-mail. An update content is attached to the e-mail by being formatted based on RSS specification, which describes the outline of Web site as metadata in brief. RSS means “RDF Site Summary” or “Rich Site Summary”. The description specification of RSS is suitable for expressing update information of Web page, because the description specification of RSS belongs to a document expression standard called RDF (Resource Description Framework) meeting XML standard and can provide an expression format capable of browsing in a common framework, regardless of a difference of the constitution of various kinds of Web pages. On the other hand, the user terminals 4a-4c include an application program called reader (hereinafter, referred to as RSS reader) which obtains data described based on RSS specification (hereinafter, referred to as RSS data) and displays the data. The RSS data is tagged data based on xml format, and the tag information provides format information for specifying a string attribute of the document. Consequently, a user can browse update content with possible various contents in a common framework by using a reader corresponding to the format. In addition, the string attribute includes information prescribing display form such as highlight of character, character modification, line feed or paragraphing. The string attribute may include information indicating a semantic attribute of phrase included in the string such as that a phrase “ABC industry” is “company name”.

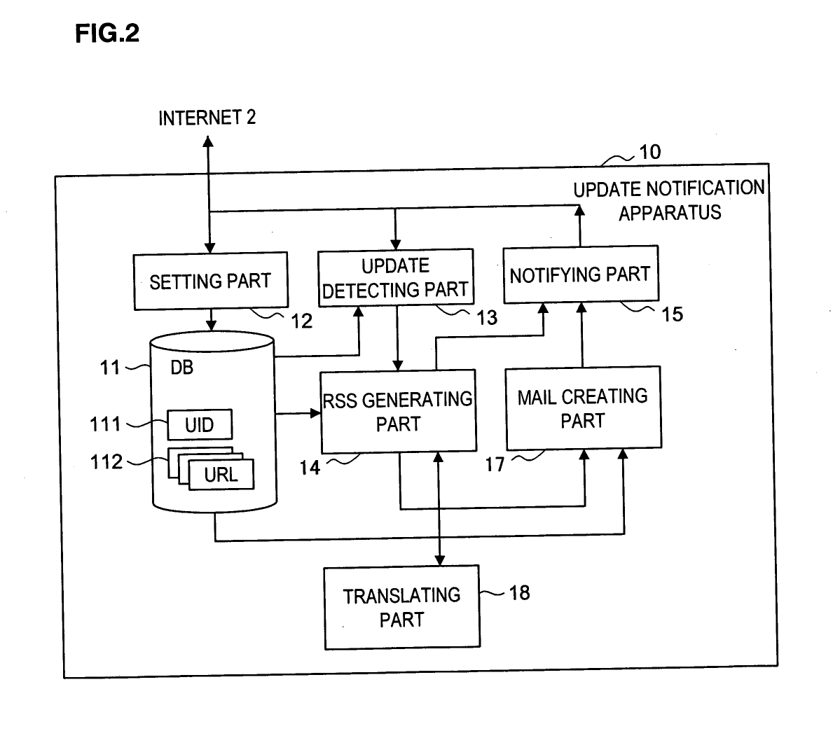

FIG. 2 is a block diagram showing a detailed configuration of the update notification apparatus 10 shown in FIG. 1. The update notification apparatus 10 is a server computer and comprises a setting part 12, an update detecting part 13, a notifying part 15, an RSS generating part 14, a mail creating part 17 and a database (also called DB) 11.

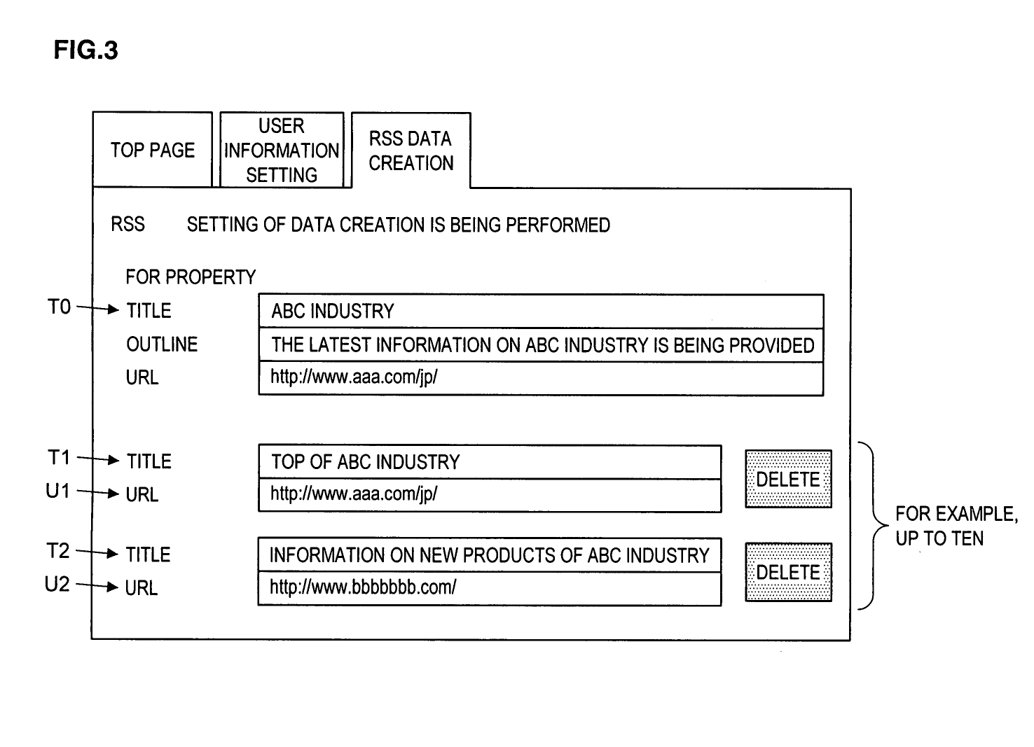

The setting part 12 accepts the registration of users and address of Web site for confirming whether update have been carried out through the communication with each of the user terminals 4a-4c, and stores the address in the DB 11. The communication with the user terminals 4a-4c can be carried out through the Web page shown in FIG. 3 to be described later.

The DB 11 is one example of a notified party address holding part. The DB 11 comprises an UID table 111 including the user information of the user terminals 4a-4c of the update notified party and an URL table 112 for every user. For the UID table 111, an identifier of each user (UID) of the user terminals 4a-4c and an e-mail address of the notified party of the update content are set. For the URL table 112, at least one URL of Web page to notify of update is set for each user, i.e., for each UID. In addition, it is possible to set not only a so-called homepage address of Web site but also a specific Web page thereunder as the URL of Web site.

The update detecting part 13 accesses the Web page which corresponds to the URL stored in the DB 11 and which is distributed by the Web servers 1a-1c at specified time intervals, for example, every hour to detect the difference from the previous access. The update detecting part 13, as a detecting means for detecting a difference, may store the Web page in previous access. The contents of the Web page may be compared with those of the Web page in current access, and when update is to be implemented, the contents of the updated part may be extracted as the difference.

The RSS generating part 14 is one example of an update content generating part. The RSS generating part 14 has a function of generating RSS data in accordance with the contents of the updated part from the update detecting part 13. In other words, the update content is converted into a browsable format by the RSS reader provided in each of the user terminals 4a-4c.

The mail creating part 17 makes an RSS data file from the RSS data composed by one or more update contents generated by the RSS generating part 14 and creates a notice text by attaching the RSS data file to one notice text, which is created for each of user terminals 4a-4c to be notified parties. The notice text includes the content to notify of the update of one or more Web servers (concretely, Web site and Web page) corresponding to the URL specified by each of user terminals 4a-4c through the setting part 12. Also, the notice text may take a form of an e-mail magazine assuming a plurality of user terminals (for example, user terminals 4a-4c) are notified parties.

The notifying part 15 is one example of an update content sending part for sending the formatted update content. The notifying part 15 sends one or a plurality of notice texts created by the mail creating part 17 to each of user terminals 4a-4c. In addition, the notifying part 15 and the mail creating part 17 are collectively called an update content notifying part as well.

The update notification apparatus 10 may include a translating part 18 for translating the update content in the RSS data in original language to another language. The update content is input from the RSS generating part 14 to the translation part 18, which translates, for example, Japanese into English. Then the result of translation is output to the RSS generating part 14. In this embodiment, although the translating part 18 receives the update content from the RSS generating part 14, the translating part 18 may receive it from the update detecting part 13 or the mail creating part 17. Thereby the update notification apparatus 10 can perform update detection and update notification for a wide range of Web pages without being limited to one language.

FIG. 3 shows an example of setting in the case of requesting the update notification apparatus 10 for update notification. The screen shown in this Figure is an example of setting screen displayed on the user terminals 4a-4c accessing the update notification apparatus 10. Through this screen, a user sets at least one URL of Web page (for example, U1 and U2) to be a target of update detection and preferably sets a title (for example, T1 and T2) for each URL so as to facilitate an identification. The number of URL that a user can set may be limited to, for example, ten at maximum as shown in Figure. In addition, one unit of update notification may be identified by grouping one or more URLs of Web pages (U1 and U2) of at least one Web page to be targets of update detection and putting an update notifying title T0 for each group.

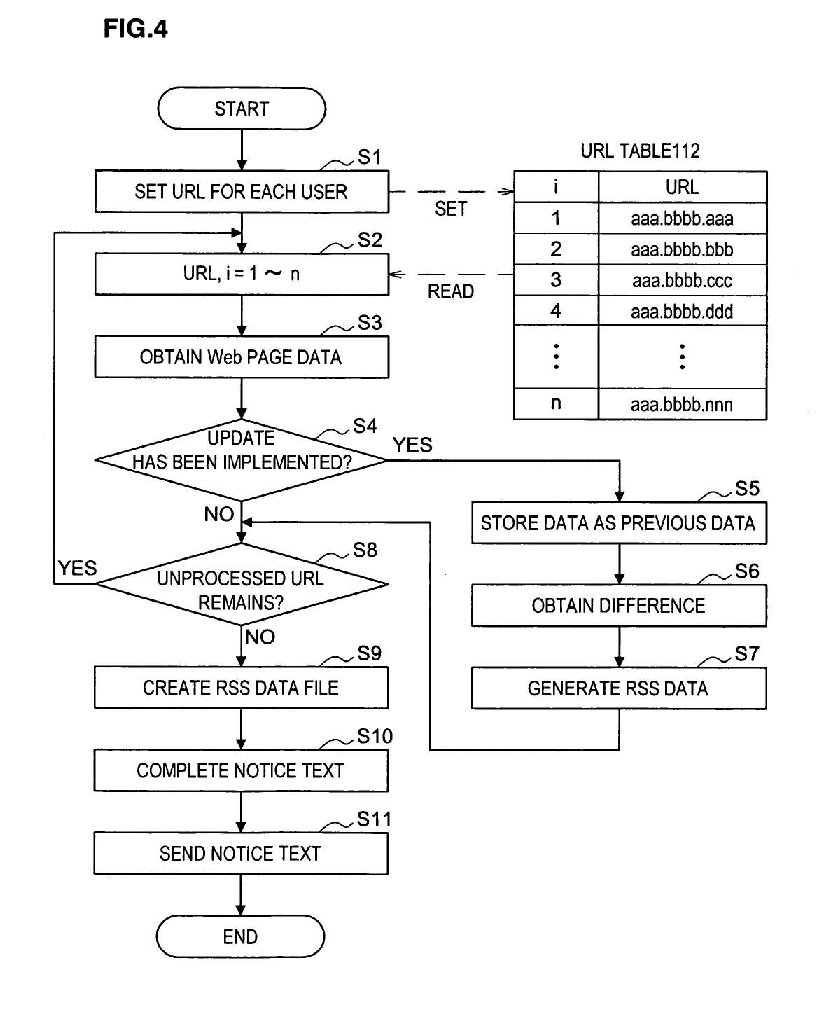

FIG. 4 shows the processing flow of the update notification apparatus 10. Description of the processing flow will be given in reference to each component of the update notification apparatus 10 appropriately. First, the setting part 12 of the update notification apparatus 10 accepts the user identifier (UID) and URLs as the network address of Web servers 1a-1c to be a target of update detection from the user terminal. The setting part 12 stores the accepted URL in the URLs table 112 of the DB 11, based on the accepted UID to set URL for each user (step S1).

Next, the update detecting part 13 of the update notification apparatus 10 reads a plurality of URLs set in the URL table 112 and starts a loop processing in the range of i=1−n (n is the number of the set URLs) (step S2). In the loop processing, an access is performed to one URL to obtain Web page data (step S3). However, when the Web page is made up of a plurality of frames, each page data in the frames is obtained and held. In the next, the obtained Web page data (hereinafter, also referred to as current data) is compared to the data in the previous access (hereinafter, also referred to as previous data) to branch into step S5 when the update has been implemented while into step S8 when the update has not been implemented (step S4).

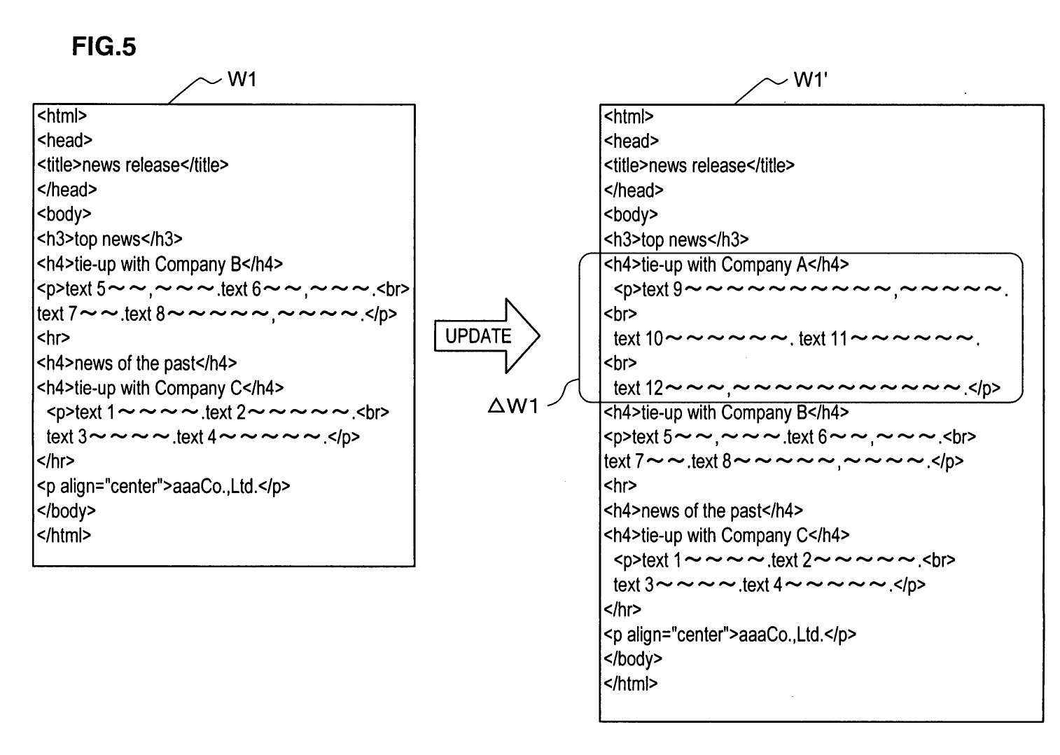

When the Web page has been updated, the update detecting part 13 stores the obtained data as the previous data for the next time (step S5). And then the update detecting part 13 obtains the difference between the previous data and the current data (step S6). This difference can be obtained by, for example, storing each line of previous and current data in array and repeating a comparison between one array element of previous data and all array elements of current data for all array elements of previous data (see FIG. 5). Next, the RSS generating part 14 of the update notification apparatus 10 generates RSS data by using the difference extracted in step S6 (step S7).

Next, the update detecting part 13 of the update notification apparatus 10 judges whether there remains an unprocessed URL or not and in the case of remaining, there goes back to step S2 to process the next URL. In the case of not remaining there proceeds on to step S9 (step S8). In this case, the mail creating part 17 of the update notification apparatus 10 combines one or more RSS data generated in step S7 to create the RSS data file (step S9). The RSS data file includes a plurality of update contents corresponding to a plurality of URLs by including one or more update contents separated by <item>˜</item>. In the next, the mail creating part 17 attaches the RSS data file to the notice text addressing to one user terminal to complete the notice text (step S10). Then the notifying part 15 of the update notification apparatus 10 sends the completed notice text as an e-mail to the user terminal, i.e., one of the user terminals 4a-4c in which the URLs corresponding to the update contents are set as the update-detected party (step S11).

The notice text created in step S10 may be sent by calling CGI of Web server function provided in the user terminal instead of sending by e-mail. In this case, the RSS data file can be sent to the user terminal by using POST method and setting the user terminal's address of notified party and the name of RSS data file as the address of notified party as the parameter. However, since there is a concern about the load of Web server accepting the RSS data and the trouble of response process in calling CGI, it is more preferable to send the notice text by e-mail. In the form of sending by e-mail, the timing of processing can be controlled by storing means such as spool in a mail server, which makes it possible to reduce the load. The above steps S1 to S11 are repeated for a plurality of users of the user terminals 4a-4c, i.e., by the number of user to be notified of update by the update notification apparatus 10.

FIG. 5 is an explanatory diagram for showing a method of obtaining a difference as an update content in the processing flow shown in FIG. 4. In FIG. 4, each of Web pages W1 and W1′ is shown as text format expressed by tag in HTML. The Web page W1 is changed to the Web page W1′ by update. In this case, a difference ΔW1 is obtained by obtaining the difference in step S6 in FIG. 2. In this example, the difference ΔW1 is an added new content, that is, “tie-up with Company A (line feed) text 9 ˜˜˜˜˜˜˜˜˜˜, ˜˜˜˜˜(line feed) text 10 ˜˜˜˜˜˜. text 11 ˜˜˜˜˜˜. (line feed) text 12 ˜˜˜, ˜˜˜˜˜˜˜˜˜˜˜.”.

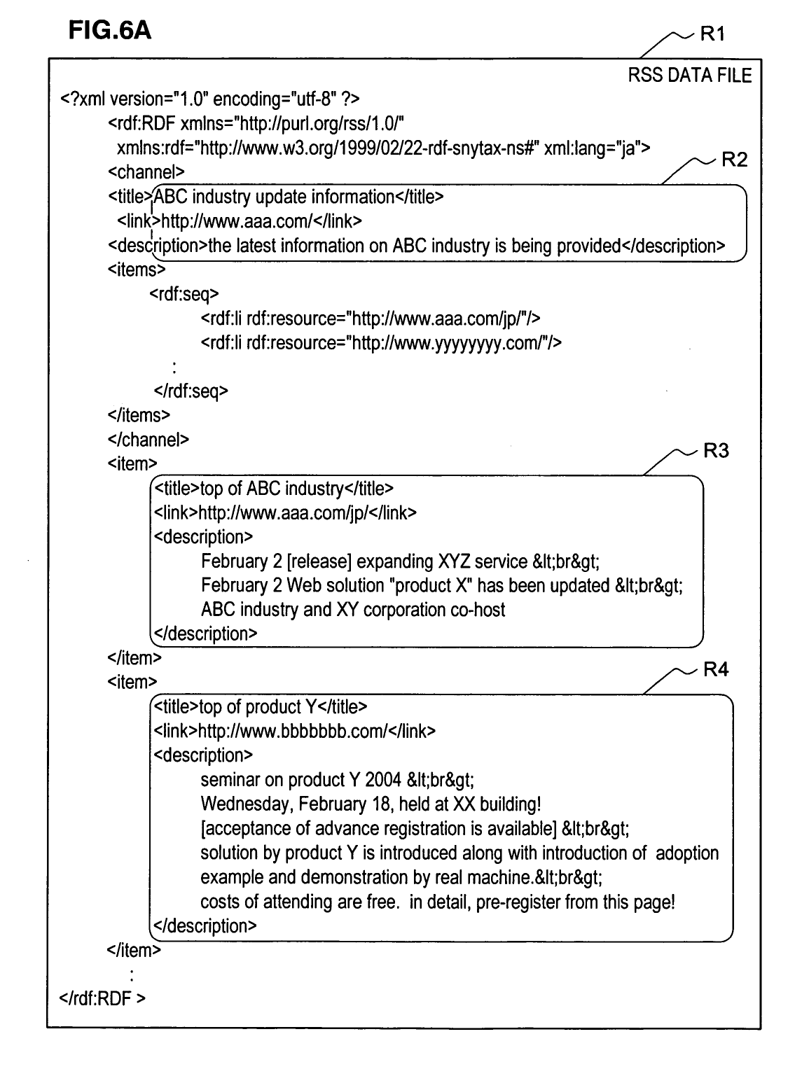

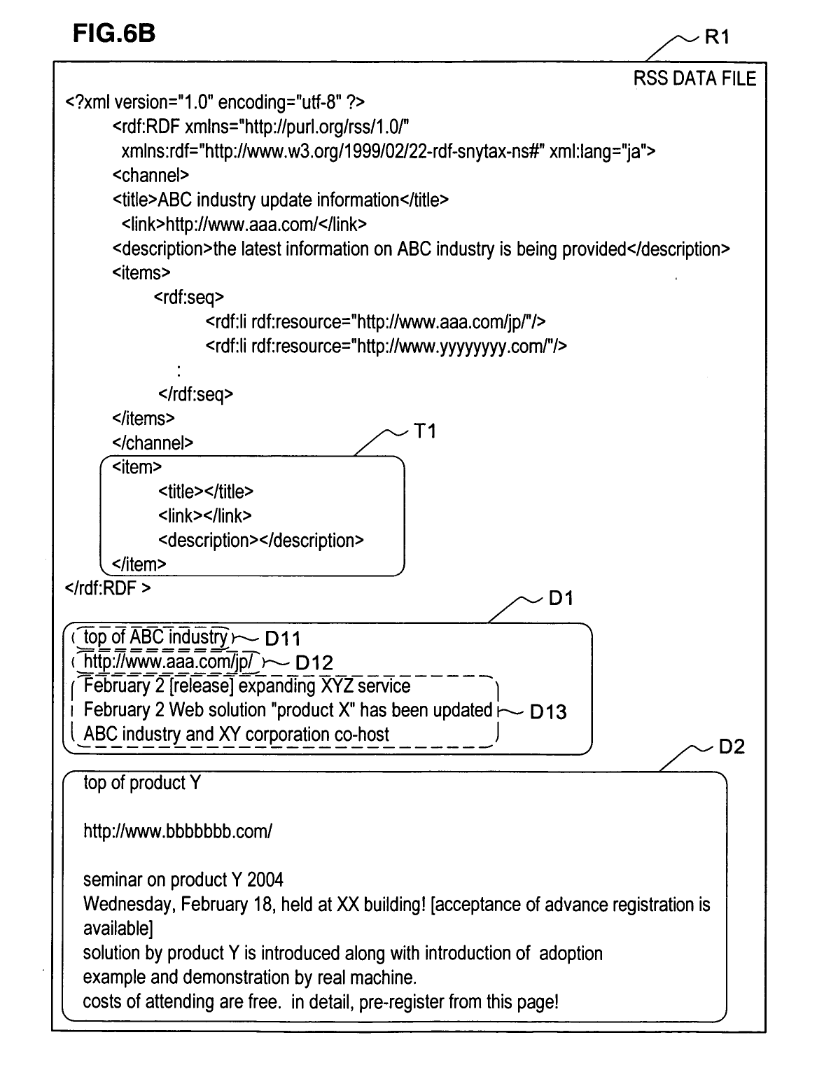

FIG. 6A is an explanatory diagram for RSS data generated based on the update content. The RSS data is generated with the provision of the update content with attribute information called tag by the RSS generating part 14 of the update notification apparatus 10. In the generation of this RSS data, for example, a column <item>˜</item> is provided corresponding to one URL. The title of the update content corresponding to one URL is described in a column <title> under <item>. The update content is described in a column <description>˜</description>.

According to the example of FIG. 6, the RSS data file (R1) constitutes one unit of update notification. The title of update notification is provided with the RSS data file (R1) by a description (R2) as shown in Figure. Concretely speaking, the title of update notification by the RSS data file (R1) is “update notification of ABC industry”. Further, the RSS data file (R1) includes a series of description element “<item>, <title> title name </title>, <url> URL </url>, <description> update content </description>, and <item>” in one URL for a plurality of URLs (R3 and R4). For example, referring to R3, there is described such an update content as “Feb. 2 [release] expanding XYZ service . . . ” for one URL “www.aaa.com/jp”. Consequently, one RSS data file (R1) includes the update contents for a plurality of URLs. However, it is not necessary for the RSS data file (R1) to be filled with all information and to include the update content, only notifying of update.

FIG. 6B shows another example of RSS data generated based on the update content. In this example, update contents D1 and D2 are constituted separately from tag information T1 corresponding thereto. The tag information T1 corresponds to both of the update contents D1 and D2 and defines the formats of the update contents D1 and D2. The update content D1 tries to correspond to each description element in the tag information with the constitution of dividing into blocks of a title part D11, a URL part D12 and a content part D13. The same goes for the update content D2. The form of RSS data as shown in this Figure makes it possible to reduce the amount of data in the update notification.

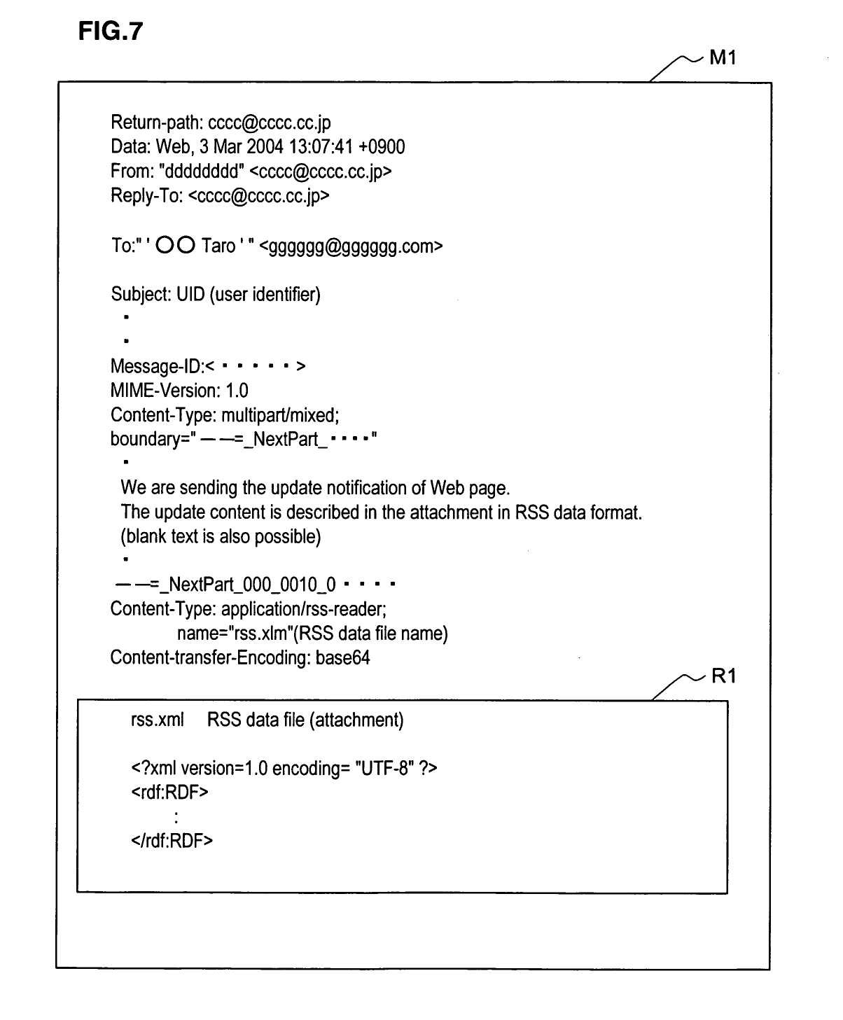

FIG. 7 shows an example of content of a notice text including the update notification and the update content. Referring to this Figure, the notice text is shown as an e-mail M1. The user identifier (UID) is set as Subject of the e-mail, and a blank text or an appropriate notice text is described. The RSS data file R1 of file name “rss.xml” is attached thereto like <?xml version=1.0 encoding=“UTF-8”?>, <rdf:RDF> . . . </rdf:RDF>.

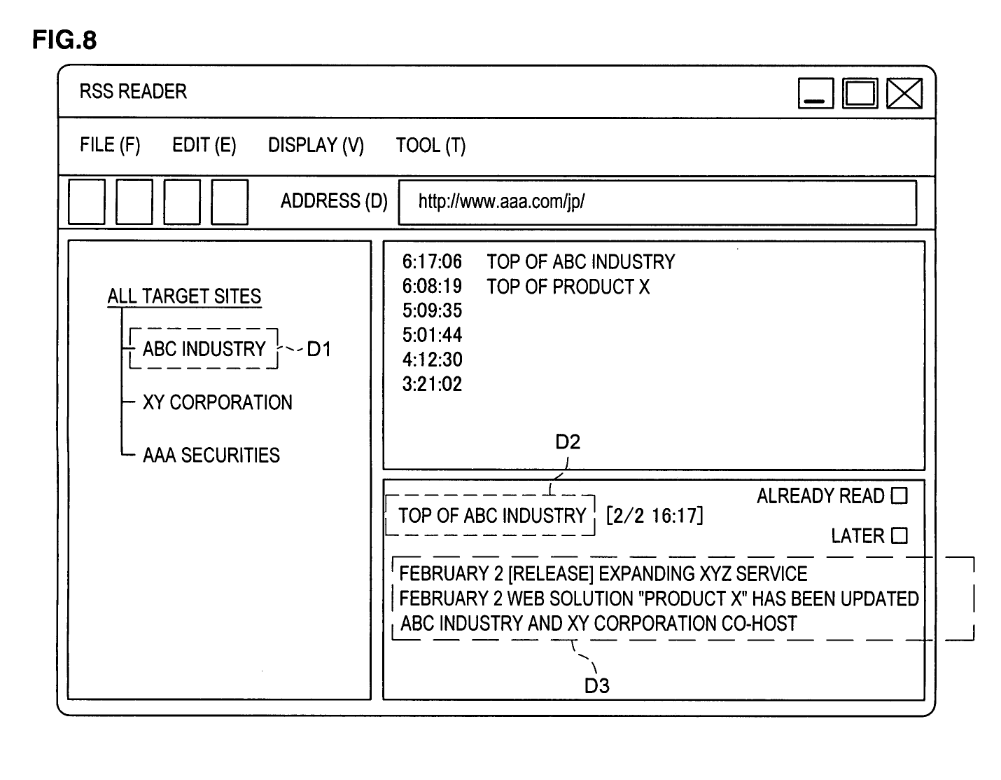

FIG. 8 shows an example of screen in the case of browsing the update notification and the update content by an RSS reader. A user browses normally off-line the RSS data file attached to the notice text of e-mail sent from the update notification apparatus 10 by using the RSS reader of user terminal. The user can also browse online the RSS data received by using the Web server function of the user terminal by using the RSS reader. In the screenshot of RSS reader in this Figure, the title of update notification sent in one notice text is displayed as data D1 “ABC industry”. Also, an update title corresponding to one URL is displayed as data D2 “top of ABC industry”. The update content corresponding thereto is displayed as data D3 “Feb. 2 [release] expanding XYZ service . . . ”.

In the first embodiment as described above, the update notification apparatus 10 extracts the difference between data such as HTML data stored after obtaining in the previous detection to detect the update and the data obtained this time after comparison therebetween. The content of difference thus extracted is converted into RSS data, attached to an e-mail and notified to a user. The user can receive collectively the update contents of a plurality of Web pages as the RSS data file in a single notification. The user can view the update situation of various Web pages in an integrated fashion regardless whether the update information is provided or not by RSS from the Web server itself, by browsing this RSS data file by the RSS reader.

### Second Embodiment

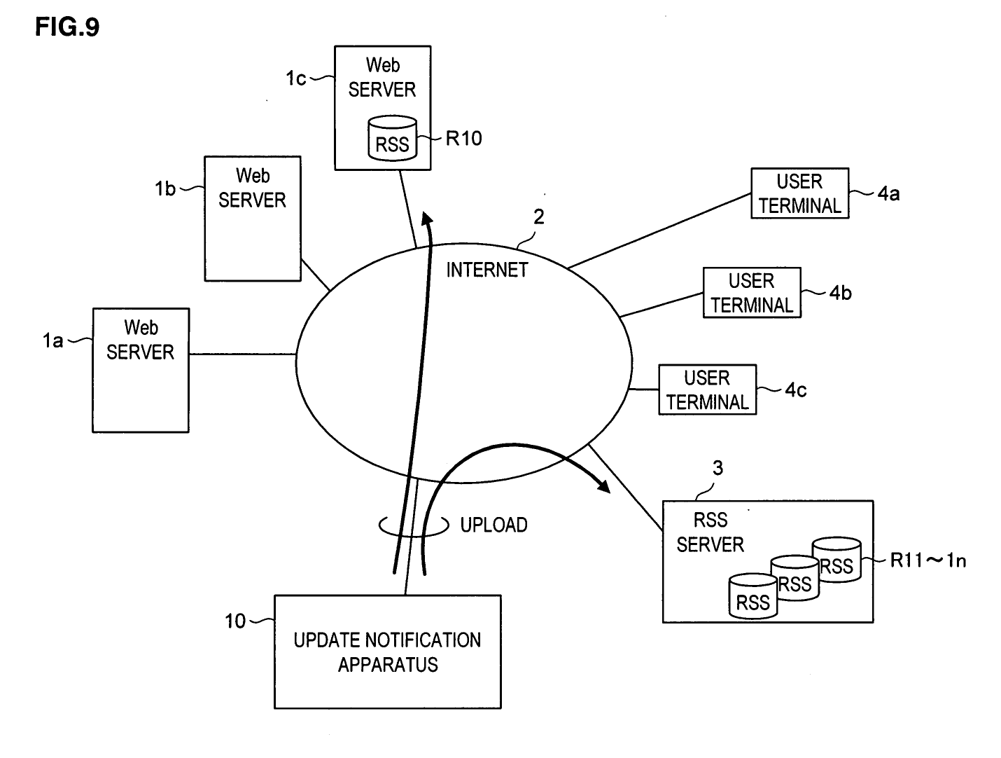

FIG. 9 shows the second embodiment of the invention and the whole configuration including the update notification apparatus 10. The update notification apparatus 10 is connected to a plurality of Web servers 1a-1c and a plurality of user terminals 4a-4c through the Internet 2, similarly to the first embodiment. In the second embodiment, one of the Web servers 1a-1c, for example, the Web server 1c holds the RSS data file R10 reflecting the update of Web page of its own. The RSS data file R10 is sent, i.e., uploaded by the update notification apparatus 10 as a notice text to the preset Web server's address. Thereby the Web server 1c can release the Web page of its own and the update content corresponding thereto to the user terminals 4a-4c and other computer terminals (not shown). As a concrete example, a description will be given about setting the Web server 1c. Setting the site address of Web server 1c as “http://abc.provider.cojp/taro/” and the RSS data file as “rss.xml”, the creator or operator of the above site can release the RSS data by arranging the RSS data file received as the attachment of e-mail like “http://abc.provider.co.jp/taro/rss/rss.xml ”.

As the modification of this embodiment, an RSS server 3 may be further connected to the Internet 2 and hold a plurality of RSS data files R11-R1n (n is a positive number). The RSS server 3 is connected to the Internet 2 and is a server computer for releasing the RSS data to many computer terminals (not shown)-including the user terminals 4a-4c. A plurality of RSS data files R11-R1n are sent, i.e., uploaded by the update notification apparatus 10 as a notice text. A plurality of user terminals 4a-4c, on the other hand, can browse all the RSS data in the Web servers 1a-1c only by accessing the RSS server 3, with the RSS reader provided. Also, access may be restricted so that only a user requesting the creation of RSS data can access the aforementioned RSS data.

As seen in the above embodiments, the update notification method and the update notification apparatus according to the invention can not only send the update notification to a specific user but also provide the update content together with the format information for specifying a string attribute such as RSS format, with the user terminal of the user. Thereby it is possible for a user browse not only the update information of Web site by which the RSS data is provided but also the update information of Web site by which the RSS data is not provided, only by including software fitting an appropriate format such as RSS reader in the user terminal. The provider of Web page, on the other hand, can release the RSS data easily without generating the RSS file by hand.

In addition, as one form of realizing the update notification method according to the invention, it may be possible to send the data on the update content before converting into RSS data from the update notification apparatus to the Web server to implement RSS format conversion in the Web site. Further, it may be possible to send the data on the update content before converting into RSS data from the update notification apparatus to the RSS server to have converted and released by the RSS server.

Although the preferred embodiment of the present invention has been described referring to the accompanying drawings, the present invention is not restricted to such examples. It is evident to those skilled in the art that the present invention may be modified or changed within a technical philosophy thereof and it is understood that naturally these belong to the technical philosophy of the present invention.

As a usage pattern of the update notification method and the update notification apparatus according to the invention, it is assumed that a Web site surfer browsing a Web site on a routine basis commissions an operator of update notification apparatus to prepare an update notification and create RSS data, and that a Web site operator commissions an operator of update notification apparatus to create RSS data.

In the former case, the Web site surfer can enjoy the notification service for the update content converted into RSS data by receiving the update notification of a desired Web page from the update notification apparatus. Furthermore, the Web site surfer can browse the RSS data from the update notification apparatus as well as the update information of Web site providing the RSS data by using the RSS reader. In the latter case, on the other hand, the Web site operator only has to provide the RSS data received from the update notification apparatus on a specific position without the necessity of creating the update information by hand, and can be devoted to the Web site operation.

1. An update notification method for notifying update of web page externally comprising:
a step of accessing repeatedly at least one web site or web page identified by a preset address;
an update content extracting step for extracting an update content from the web page when the web site or web page is updated;
an update content generating step for generating a formatted update content providing format information for specifying a string attribute of the update content to the update content; and
an update content notifying step for notifying the formatted update content externally.

2. An update notification method according to claim 1, wherein the update notification method further comprises a notified party address holding step for holding an address of at least one user terminal to be notified of update by relating to each of the at least one web site or web page, and the update content notifying step comprises a step of sending the formatted update content to the user terminal in accordance with the held address.

3. An update notification method according to claim 2, wherein the step of sending the formatted update content is carried out by e-mail.

4. An update notification method according to claim 2 comprising:
a step of receiving an address of the at least one web site or web page from the user terminal; and
a step of storing the received address by relating to the address of the user terminal.

5. An update notification method according to claim 1, wherein the update notification method further comprises a notified party address holding step for holding an address of at least one Web server to be notified of update by relating to the at least one web site or web page, and
the update content notifying step comprises a step of sending the formatted update content to the Web server in accordance with the held address.

6. An update notification method according to claim 5, wherein the step of sending the formatted update content is carried out by e-mail.

7. An update notification method according to claim 1, wherein the update content extracting step extracts the update content in accordance with a difference in character, line or block between previous and current contents of the web page.

8. An update notification method according to claim 1 further comprising a step of translating the update content in original language to another language.

9. An update notification method according to claim 1, wherein the format is based on RSS.

10. An update notification apparatus for notifying update of web page externally comprising:
an update detecting part for accessing repeatedly at least one web site or web page identified by a preset address, and extracting an update content from the web page when the web site or web page is updated;
an update content generating part for generating a formatted update content providing format information for specifying a string attribute of the update content to the update content; and
an update content notifying part for notifying the formatted update content externally.

11. An update notification apparatus according to claim 10, wherein the update notification apparatus further comprises a notified party address holding part for holding an address of at least one user terminal to be notified of update by relating to each of the at least one web site or web page, and
the update content notifying part comprises an update content sending part for sending the formatted update content to the user terminal in accordance with the held address.

12. An update notification apparatus according to claim 11, wherein the update content notifying part further comprises a mail creating part for creating an e-mail including the formatted update content; and
the update content sending part sends an e-mail created by the mail creating part to the address of the user terminal.

13. An update notification apparatus according to claim 11 further comprising a setting part for receiving an address of the at least one web site or web page and storing the received address in the notified party address holding part by relating to the address of the user terminal.

14. An update notification apparatus according to claim 10 wherein the update notification apparatus further comprises a notified party address holding part for holding an address of at least one Web server to be notified of update by relating to the at least one web site or web page, and
the update content notifying part comprises an update content sending part for sending the formatted update content to the Web server in accordance with the held address.

15. An update notification apparatus according to claim 14, wherein the update content notifying part further comprises a mail creating part for creating an e-mail including the formatted update content; and
the update content sending part sends an e-mail created by the mail creating part to the address of the Web server.

16. An update notification apparatus according to claim 10 wherein the update content extracting part extracts the update content in accordance with a difference in character, line or block between previous and current contents of the web page.

17. An update notification apparatus according to claim 10 further comprising a translating part for translating the update content in original language to another language.

18. An update notification apparatus according to claim 10, wherein the format is based on RSS.
